(19) United States
(12) Patent Application Publication
(10) Pub. No.: US 2024/0166087 A1
(43) Pub. Date: May 23, 2024

(54) Heat Management System for an Electrified Motor Vehicle

(71) Applicant: Bayerische Motoren Werke Aktiengesellschaft, Muenchen (DE)

(72) Inventors: Esther ALBERTS, Muenchen (DE); Andreas BILLERT, Garching (DE); Simone FUCHS, Muenchen (DE)

(21) Appl. No.: 18/283,137

(22) PCT Filed: Apr. 6, 2022
(86) PCT No.: PCT/EP2022/059054

§ 371 Date: Sep. 20, 2023

(30) Foreign Application Priority Data
May 7, 2021 (DE) 10 2021 111 961.8

(51) Int. Cl. B60L 58/26; B60L 58/27

(52) U.S. Cl. CPC B60L 58/26; B60L 58/27; B60L 2240/545; B60L 2240/622; B60L 2260/56

(57) ABSTRACT

A heat management system includes an electronic control unit configured to determine at least one route section-related historical heating or cooling effect profile based on heat management-relevant data of a navigation system acquired for a predefined period, acquire, for the same predefined period, a route section-related historic temperature profile by sensor for each component, determine at least one route section-related predicted heating or cooling effect profile based on the heat management-relevant data of the navigation system, which are predictable for at least one predefined horizon, and ascertain a predicted temperature profile for each component on the basis of the historic heating or cooling effect profile, the historical temperature profile, and the predicted heating or cooling effect profile.

### FIELD

The invention relates to a heat management system for an electrified motor vehicle, which in particular includes a high-voltage storage device and various further heat management-relevant components.

### BACKGROUND AND SUMMARY

Heat management systems are already partially known, for example, in the form of heating and/or air-conditioning systems for the interior and/or high-voltage storage device temperature control (for heating and/or cooling), in particular for electrified motor vehicles. Heat management for the interior and a high-voltage storage device of an electrified vehicle is known, for example, from DE 10 2014 226 514 A1.

For the drive of an electric or hybrid vehicle, it comprises a drivetrain having an energy storage device for the energy supply. This is typically a correspondingly suitably dimensioned high-voltage battery, which is also designated hereafter as a high-voltage storage device. This typically heats up during charging or discharging processes, wherein the risk of power degradation, which is permanent in particular, or a reduction of the service life of the high-voltage storage device exists in the event of excessive heating. Therefore, it is typically cooled accordingly in operation and is often connected to an air-conditioning circuit of the vehicle for this purpose, which is also used for the interior climate control. This air-conditioning circuit has a defined performance, i.e., a defined maximum cooling potential, which can be used to cool the interior and the high-voltage storage device. Depending on the cooling demand of the two components, a conflict possibly occurs here such that the cooling potential is not sufficient to serve the respective cooling demand at the high-voltage storage device and in the interior. Depending on the prioritization of the distribution of the cooling potential, either increased thermal strain of the high-voltage storage device or a loss of comfort in the interior are to be expected in this case.

In order to reduce the energy consumption in climate control of the interior and obtain an extended range of the vehicle due to a reduced energy withdrawal from the high-voltage storage device in an electric or hybrid vehicle, according to the prior art, a device for climate control of a passenger compartment and an energy storage device for exchanging a cooling medium are, for example, thermally coupled with one another. It is thus possible in specific situations to initially exchange heat between these two components, instead of activating the device for climate control. For example, thermal energy, in particular waste heat, of the energy storage device is absorbed and emitted to the device for climate control of the passenger compartment. This takes place as long as an actual temperature of the passenger compartment is within a specified temperature range. In this way, cooling of the energy storage device takes place without having to activate the device for climate control. The discharged heat is emitted into the passenger compartment, but only as long as its temperature is in the specified temperature range.

In the above-mentioned prior art, an electric or hybrid vehicle includes an interior and a high-voltage storage device, both of which can be climate-controlled by means of an air-conditioning system of the vehicle, wherein the air-conditioning system has a defined cooling potential. Here, the high-voltage storage device (HVS) has a current HVS temperature and the interior has a current interior temperature. In a preconditioning mode, the high-voltage storage device is undercooled by means of the air-conditioning system to an HVS temperature below an HVS operating temperature for preconditioning of the high-voltage storage device.

The high-voltage storage device is thus cooled by means of the air-conditioning system, although presently there is no cooling requirement with respect to the high-voltage storage device and the current HVS temperature assumes a value below the HVS operating temperature. Undercooling of the high-voltage storage device below its HVS operating temperature thus advantageously takes place. A cold buffer is then advantageously created by this so-called preconditioning, which postpones in time the point in time of a possible cooling requirement on the high-voltage storage device. Due to the cold buffer, heating of the high-voltage storage device without performance degradation due to excessively strong heating is possible, without having to use the air-conditioning system to cool the high-voltage storage device. This system is then in particular exclusively available for cooling the interior with full cooling potential. In this manner, the high-voltage storage device also forms a cold reservoir with respect to its own climate control. The preconditioning of the high-voltage storage device in particular already takes place predictively in those phases in which typically no or only minor cooling of the high-voltage storage device would take place.

Outside the preconditioning mode, in particular the HVS temperature is regulated to the HVS operating temperature, which is within a suitable HVS operating temperature range, in order to avoid power degradation or damage.

Thus in summary, preconditioning of the high-voltage storage device with consideration of the high-voltage storage device as a cold buffer for relieving the energy demand of the air-conditioning system for the interior during the journey takes place in DE 10 2014 226 514 A1.

The possibility is already taken into consideration here of taking into consideration future temperatures of interior and high-voltage storage device on the basis of navigation data in the undercooling.

Furthermore, a prediction of the desire for preconditioning on the basis of usage data, such as weather and predicted duration of stay, is known from WO 2019/238389 A1. The vehicle user receives a message and has to confirm the recommended preconditioning.

Finally, US 2019/0390867 A1 forms prior art, which applies the method of so-called “reinforcement learning” in conjunction with heat management for air-conditioning systems, in order to fundamentally improve the quality of a temperature regulation.

In DE 10 2021 101 513 of the applicant (no prior publication), a heat management system is described as a climate control system for an electrified motor vehicle, which includes an interior and a high-voltage storage device, comprising an air-conditioning system and an electronic control unit, wherein the air-conditioning system is designed for climate control of both the interior and the high-voltage storage device and wherein the control unit includes a preconditioning module for carrying out a preconditioning mode during the charging of the parked vehicle before starting the journey. The preconditioning module is designed such that at least the length of the route and the external temperature over the length of the route are predictable and such that the high-voltage storage device is usable either as a heat storage device or as a cold storage device depending on this prediction.

It is an object of the invention to improve the heat management for diverse energy-consuming components in an electrified motor vehicle, including the high-voltage storage device, with respect to efficiency and optimization during the journey.

This object is achieved according to the invention by the features disclosed herein. Advantageous embodiments, refinements, and variants are also the subject matter of the present disclosure.

A heat management system for an electrified motor vehicle having various defined heat management-relevant components is disclosed, in particular having a high-voltage storage device and having an electric machine, having at least one thermo module, controllable by a control module, per defined component, having a navigation system and having at least one electronic control unit comprising the control module and a prediction module such that by corresponding design of the prediction module, during the journey,
at least one route section-related historical heating or cooling effect profile is determined on the basis of a plurality of heat management-relevant data of the navigation system acquired for a specified duration,
for the same specified duration, a route section-related historical temperature profile for each component is acquired by sensor,
on the basis of the heat management-relevant data of the navigation system predictable for at least one specified horizon, at least one route section-related predicted heating or cooling effect profile is determined, and
a predicted temperature profile is ascertained for each component on the basis of the historic heating or cooling effect profile, the historic temperature profile, and the predicted heating or cooling effect profile.

The invention is based on the following considerations:

The invention preferably uses so-called “reinforcement learning”, which is fundamentally known as a method of machine learning. It is therefore to be regulated by means of prediction when the high-voltage storage device and other heat management-relevant hardware components of a vehicle onboard energy system are (have to be) cooled or heated.

Heat flows and the component and interior temperatures resulting therefrom are strongly dependent on the usage of the vehicle, which comprises the (individual) driving profile and external influences, for example, due to the road profile or the weather conditions. In addition, the components and passengers have different requirements for their optimum operating temperatures and different thermal masses (or time constants). The efficiency of the heat transfer between these components, and the power coefficient of heatsinks and sources are also dependent on various internal and external influences.

Therefore, optimized heat management of the hardware components of the onboard energy system and the interior have to follow complex interdependencies including external influences, which are not or are at least not yet completely taken into consideration by current operating strategies. These interdependencies can preferably be taken into consideration with the aid of a reinforcement learning approach to find optimum heat management strategies for the driving profile and the external influences on a vehicle. One part of the heat management-relevant components can be the high-voltage storage device, the electric motor, the vehicle occupant cabin, and further heating and cooling elements. In current heat management systems, these heating and cooling components can be electrical heaters, pumps, electrical refrigerant compressors, inlet air flaps, and cooling fans.

### Technical Problem

Current heat management strategies are not optimally adapted to the customer and the driving behavior of the customer (for example, duration, acceleration). They do not deal with all (combinations of) external influences during the journey, such as information about the behavior of the driver and the upcoming driving route. In consideration of individual, partially contradictory requirements of the components and passengers for their optimum temperatures, more complex heat management strategies have to be derived.

In current solutions, such as, e.g., by means of individual characteristic diagram tables for each component of the heat management, energy is wasted, since properties and needs are not taken into consideration in the context of the overall system and external influences. In addition, current systems do not observe an optimum point of the overall energy consumption over all components, since the dependence of the coefficient of power (COP) of these components and the dependence of efficiencies for the heat transfer between the components on external factors are neglected.

The amount of the resulting combinations and situations which have to be dealt with by heat management strategies results in an increasing demand for intelligent algorithms, which can identify an optimum strategy for every situation. In contrast thereto, current implementations use greatly simplified functions and are therefore not capable of accurately modeling the interdependencies and reacting appropriately and flexibly. In current systems, the set of possible combinations and triggers is limited, however, and therefore cannot deal with the variety of the requirements and situations. In addition, current strategies, which offer all customers an optimum driving performance up to very dynamic driving behavior, lack efficiency optimization in the event of moderate acceleration requirements. Therefore, individual strategies have to be derived for each driver.

Basic Principle of the Invention (Basic Concept):

One basic concept according to the invention is to model the problem in order to predict when hardware components of the onboard energy system should be actively cooled or heated, as a reinforcement learning problem.

In “reinforcement learning”, a so-called “agent” learns to take actions which are based on rewards and/or penalties (in FIG. 4, the principle of “reinforcement learning” (RL), which is known per se, is outlined as a mathematical method).

Requirements as described in the section of the technical problem can be modeled by individual rewards, for example, using negative rewards for temperatures to be avoided and (higher) positive rewards for optimum temperatures. This refers, for example, to high-voltage batteries being subject to an elevated internal resistance, thus a lower power availability, at low temperatures and increased aging at high temperatures. In addition to meeting the requirements of the components, the overall energy consumption has to be minimized and the efficiency of the heat transfer has to be taken into consideration. Thermal management strategies can comprise measures such as activating and controlling components of the heat management system, which result in the cooling or heating of the system or parts thereof. Actions of an intelligent algorithm (for example using reinforcement learning) can trigger a combination of these components depending on the situation. Such a situation is defined by various environmental parameters or statuses, which can contain information about the components, the cabin, navigation data, and weather information.

Example of the implementation of the invention:

Only the main aspects are mentioned hereinafter. Advantageous embodiments of the invention will be explained in more detail on the basis of the drawing:
The environment is modeled using multiple onboard signals.
Based on the current and earlier statuses, an “agent” learns to take measures according to a guideline.
The reward is influenced by multiple factors.
To learn the guideline, it is proposed according to the invention that a network (DQN; neural network) be trained, which outputs actions based on statuses (by estimations of q values for status, action pairs).

The invention will be explained in more detail hereinafter by means of a drawing on the basis of exemplary embodiments.

### BRIEF DESCRIPTION OF THE DRAWINGS

FIG. 1 shows a greatly simplified block diagram representation of the heat management system according to various embodiments of the invention,

FIG. 2 shows an exemplary embodiment of a predicted temperature profile for a high-voltage storage device on the basis of a historical heating or cooling effect profile (from NAV_hist and NAV_pred), of the historical temperature profile, and of the predicted heating or cooling effect profile for the high-voltage storage device,

FIG. 3 shows an example of a predicted driving route having multiple defined route sections,

FIG. 4 shows a schematic overview of the scheme of “reinforcement learning” (fundamentally prior art),

FIG. 5 shows signals, actions, and “rewards” upon application according to various embodiments of the invention of the “reinforcement learning” scheme,

FIG. 6 shows thermal thermo module control sequences and the effects thereof according to the prior art for comparison with

FIG. 7 thermal thermo module control sequences illustrated and the effects thereof according to the invention, and

FIG. 8 shows a possible processing sequence of the heat management-relevant navigation data.

### DETAILED DESCRIPTION

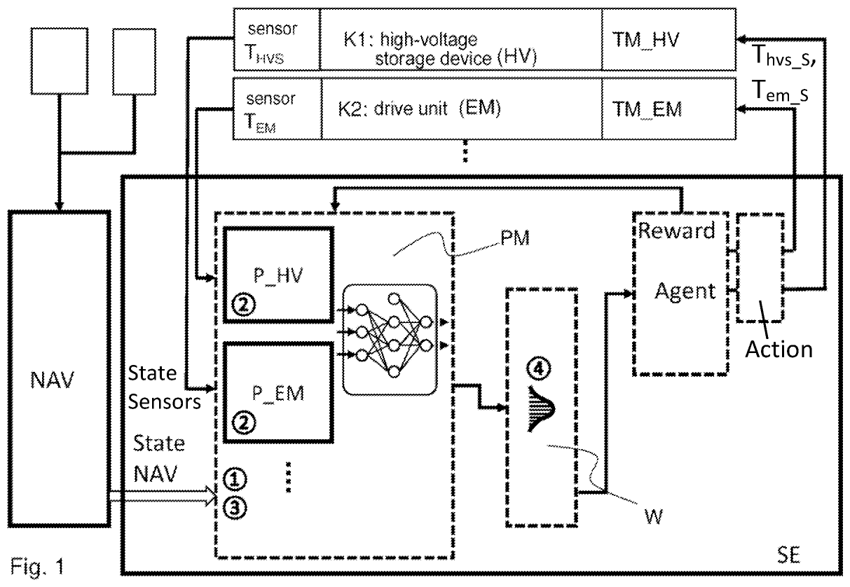

FIG. 1 schematically shows a heat management system according to the present disclosure as a block diagram.

The heat management system according to the present disclosure is provided for a plurality of defined different heat management-relevant components K1, K2, etc.—here, for example, a high-voltage storage device HV and an electric machine EM. Here, it has two heating and/or cooling thermo modules TM_HV and TM_EM, which are controllable by a control module (designated here as the “agent” from the “reinforcement learning”), per defined component HV and EM. Furthermore, the heat management comprises a navigation system NAV and an electronic control unit SE, which contains the control module “agent” and a prediction module PM.

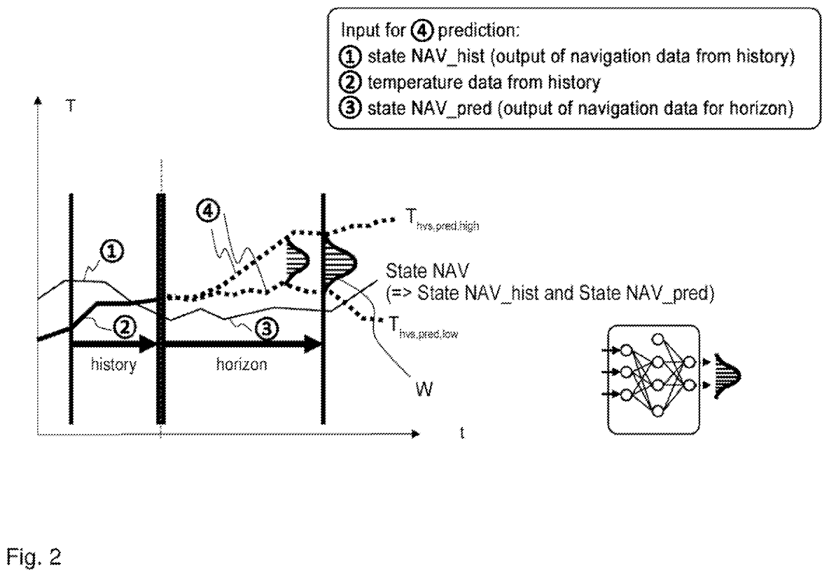

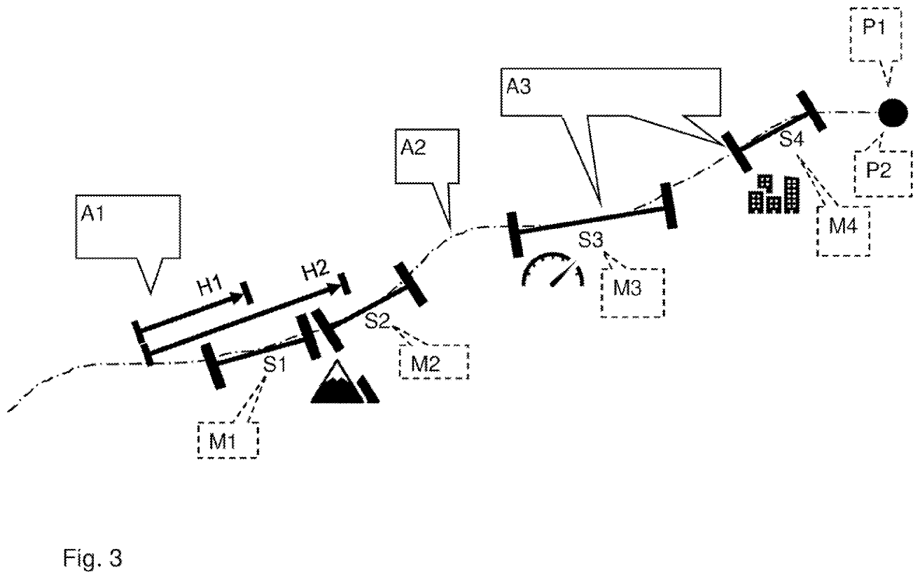

The prediction module PM is designed in particular by corresponding programming (computer program product) such that (see also FIG. 2 and FIG. 3) during the journey
on the basis of a plurality of heat management-relevant data “state NAV_hist” of the navigation system NAV, which are acquired for a specified duration (“history” in FIG. 2; H1, H2 in FIG. 3), at least one route section-related historic heating or cooling effect profile (1) is determined,
for the same specified duration (history) a route section-related historic temperature profile (2) is acquired by sensor (“state sensors”) for each component HV and EM,
on the basis of the heat management-relevant data state NAV_pred of the navigation system NAV, which are predictable for a first horizon H1 and for a second horizon H2, at least one route section-related predicted heating or cooling effect profile (3) is determined, and
on the basis of the historic heating or cooling effect profile (1), the historic temperature profile (2) and the predicted heating or cooling effect profile (3) for each component HV and EM, a predicted temperature profile (4) is ascertained.

“Heat management-relevant data” “state NAV” are, for example, route attributes as follows:
vehicle velocity
road type (including road covering/ground irregularities)
uphill slope/downhill slope
traveling downhill or traveling uphill
curve radius
outside temperature
weather (sunshine, ice, snow, . . . )
tunnel journey
RTTI (congestion, hazards, and further warnings)
energy consumption
etc.

A “thermo module” is understood as a controllable module (for example “heat exchanger”), by which the associated component can be cooled or heated.

“Route sections” are defined travel route segments predictable by the navigation system NAV, as designated in FIG. 3 by S1 to S4, for example. “Route section-related” means related to such segments S1 to S4.

The prediction module PM can contain a partial prediction module P_HV and P_EM or a partial component for a multivariate prediction for each component HV and EM.

As shown in FIG. 3, in the ascertainment of the predicted heating or cooling effect profiles (3), the predicted intrinsic heating of the components HV and EM is also taken into consideration.

“Heating or cooling effect profiles” are understood in particular as the temperature influencing by the route attributes. The route attributes act, so to speak, like a virtual additional component-independent thermo module.

The predicted temperature profile (4) is preferably ascertained in the form of a probability distribution W (over time).

“Neural networks” and “reinforcement learning” are preferably used here as mathematical functional modules.

By corresponding design of the control module “agent”, in particular the stored heating and/or cooling thresholds T_{hvs_S} and T_{em_S} for the control of the thermo modules TM_HV and TM_EM of the components HV and EM are changeable proportionally to the predicted temperature profiles (4).

FIG. 3 shows a travel route example having exemplary route attributes for the required adaptations of the cooling hysteresis or the temperature thresholds for the thermo modules of the components during the journey on the basis of the predicted temperature profiles (4):

A journey having changing environmental conditions is schematically shown. Defined route attributes or heat management-relevant data or features M1, M2, M3, and M4 are assigned to the route sections S1 to S4, for example:
M1: traveling uphill: high intrinsic heating
M2: traveling downhill: low intrinsic heating
M3: route having high velocity (for example freeway): high intrinsic heating
M4: city journey: low intrinsic heating

Further route attributes P1 and P2 can be taken into consideration, for example:
P1: journey end or pause: low intrinsic heating
P2: charging procedure: high intrinsic heating

Various prediction horizons H1 (for example for the electric motor EM) and H2 (for the high-voltage storage device HV) can be specified for the various components K1, K2, K3, etc.

Changes A1, A2, and A3 of the cooling hysteresis are carried out by the control module (or A1 module, “agent”, or regulator) on the basis of the respective prediction horizon.

A1: A downhill journey with low intrinsic heating follows: higher cooling hysteresis

A2: In the case of excessive intrinsic heating on following freeway: lower cooling hysteresis

A3: Subsequent city journey or journey end with low intrinsic heating: higher cooling hysteresis

Without input of the route destination in a navigation system, an analysis of earlier defined vehicle usage data can be performable.

For example, earlier defined and stored vehicle usage data can be analyzed to predict a minimum expected travel route.

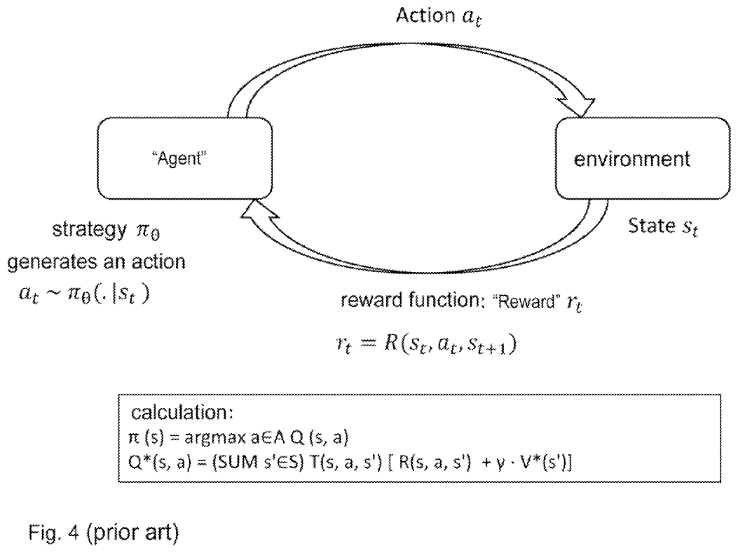

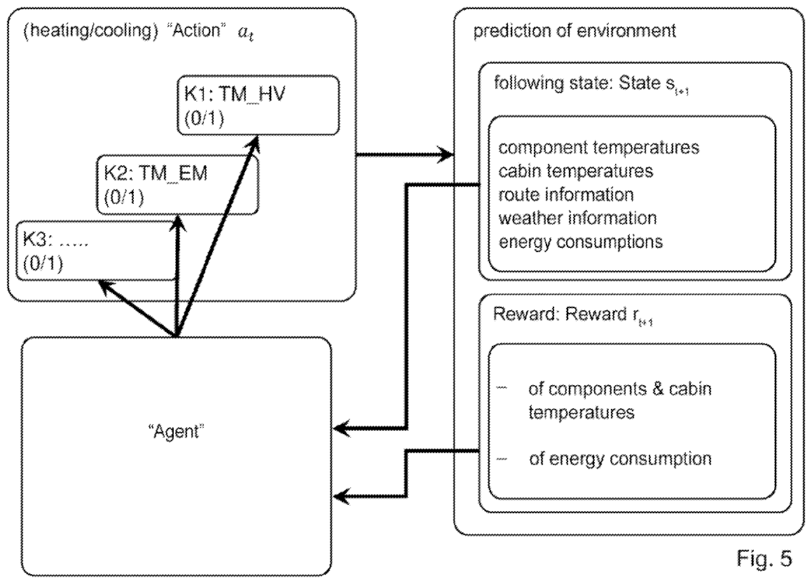

In FIGS. 4 and 5, the application of the method of the reinforcement learning to the basic concept of the invention is outlined. FIG. 4 shows a rough overview of the principle of “reinforcement learning”. A detailed example of possible signals, actions, and “rewards” in the case of application according to the invention of the “reinforcement learning” scheme is shown in FIG. 5:

Prediction of Environment:

Following State “State sₜ₊₁”:
“state”: input signals (sensor signals, navigation output data, . . . )

### Component Temperatures

high-voltage storage device (HVS)
electronic control module
electric motor
power electronics
charging unit
power cable

### Cabin Temperatures

current temperature
target temperature

### Route Information

uphill slope-speed limit
estimated velocity (for example, traffic-related)
history
active navigation (travel time, charging stops, destination)

### Weather Information

ambient temperature
humidity
wind
sunshine

### Energy Consumptions

all components, in particular the components declared in “action”.
   Reward Function “Reward rₜ₊₁”:

### Reward Function of Components & Cabin Temperatures

Current and predicted maintenance of temperature windows and avoidance of temperature peaks.
In consideration of the effects on temperature-dependent aging and performance limits.

A “reward function” is, for example, the current and predicted consideration of individual efficiencies and overall energy consumptions.

A so-called “agent” develops, similarly to a regulator having specified strategy, a better learned strategy which generates a control intervention (:=“action”) on the basis of the ascertained following state and the “reward function”.

The so-called “action” is in the present application the activation of the thermo modules TM_HV and TN_EM of the components K1 and K2 for heating or cooling by specifying a newly learned temperature threshold (for example, T_{hvs_S}, T_{em_S} in FIG. 1).

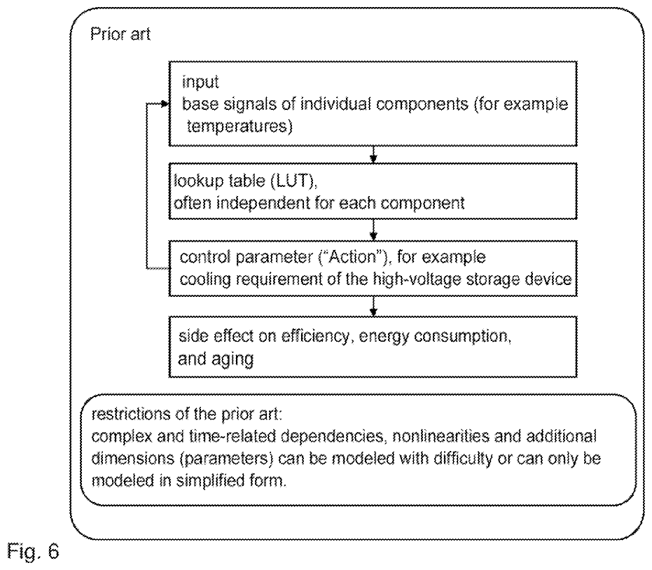

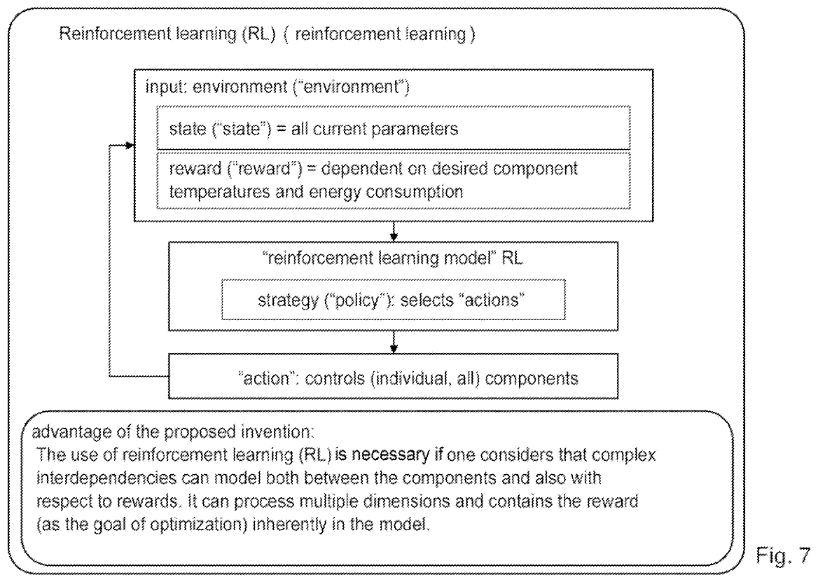

FIGS. 6 and 7 outline an overview of the difference between thermal thermo module control sequences and the effects thereof according to the prior art (FIG. 6) and thermal thermo module control sequences and the effects thereof according to the invention with preferred application of the “reinforcement learning” (RL) (FIG. 7).

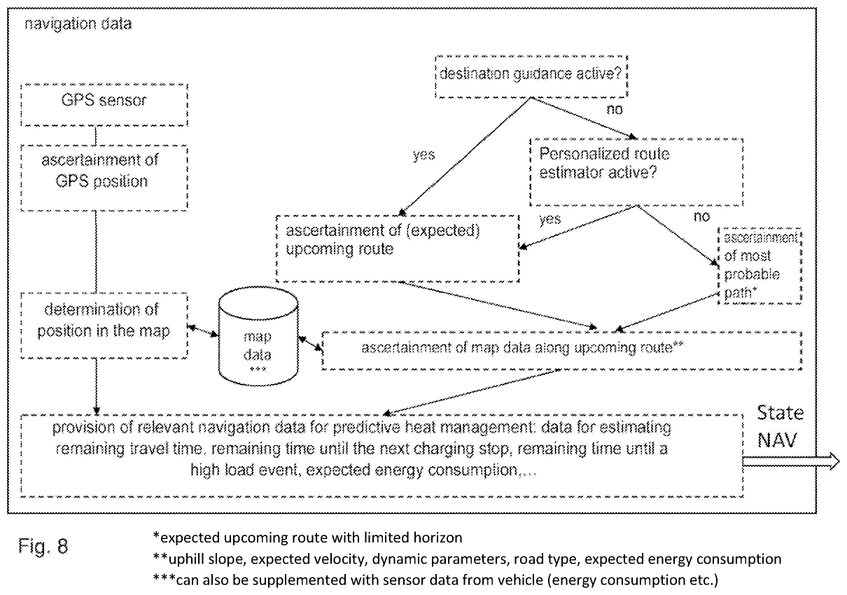

FIG. 8 shows a possible processing sequence of the heat management-relevant navigation data “State NAV” (see also FIG. 1) as the basis of the ascertainment of the historic and predicted heating or cooling effect profiles (1) and (3) (see also FIG. 2).

1-6. (canceled)

7. A heat management system for an electrified motor vehicle,
wherein the electrified motor vehicle comprises a plurality of heat management-relevant components including at least a high-voltage storage device and an electric machine,
the heat management system comprising:
at least one electronic control unit configured to:
determine at least one route section-related historic heating or cooling effect profile on a basis of a plurality of heat management-relevant data of a navigation system acquired for a specified duration of a journey;
acquire, for a same specified duration, a route section-related historic temperature profile by sensor for each of the plurality of heat management-relevant components;
determine at least one route section-related predicted heating or cooling effect profile on a basis of the heat management-relevant data of the navigation system, which are predictable for at least one predefined horizon; and
ascertain a predicted temperature profile for each component on a basis of the historic heating or cooling effect profile, the historic temperature profile, and the predicted heating or cooling effect profile.

8. The heat management system according to claim 7, wherein the at least one electronic control unit is configured to:
determine the at least one section-related predicted heating or cooling effect profile taking into consideration a predicted intrinsic heating of each component.

9. The heat management system according to claim 7, wherein the at least one electronic control unit is configured to:
ascertain the predicted temperature profile in the form of a probability distribution for each component.

10. The heat management system according to claim 7, wherein the at least one electronic control unit is configured to:
change stored heating and/or cooling thresholds for controlling of thermo modules of the components proportionally to the predicted temperature profiles.

11. A vehicle comprising the heat management system according to claim 7.
